(19) United States
(12) Patent Application Publication
(10) Pub. No.: US 2009/0086388 A1
(43) Pub. Date: Apr. 2, 2009

(54) CONTROL METHOD FOR PREVENTING MALFUNCTION OF OVER CURRENT GROUND RELAY DUE TO REVERSE POWER

(76) Inventors: Dong-Yeol Shin, Daeojon (KR); Gi-Gab Yoon, Daeojon (KR); Won-Wook Jung, Daeojon (KR); Chang-Hoon Shin, Daeojon (KR)

Correspondence Address: IPHORGAN, LTD., 1130 LAKE COOK ROAD, SUITE 240, BUFFALO GROVE, IL, 60089, US

(21) Appl. No.: 12/207,592

(22) Filed: Sep. 10, 2008

(30) Foreign Application Priority Data
Sep. 28, 2007 (KR) 10-2007-0097856

(51) Int. Cl. H02H 3/00

(52) U.S. Cl. 361/42

(57) ABSTRACT

A control method for preventing malfunction of an over current ground relay is disclosed. The control method includes: determining directions of per-phase power flows by measuring the magnitudes and phases of per-phase voltages and currents in an electric power system; checking occurrence of a load fault or a power source fault using the determined directions of per-phase power flows; and controlling an over current ground relay (OCGR) or an over current relay (OCR) to transmit a trip signal to a circuit breaker, after, upon occurrence of a load fault, checking occurrence of a ground fault and checking occurrence of a short circuit fault, and, upon occurrence of a power source fault, checking occurrence of a short circuit fault without checking occurrence of a ground fault, by turning on or off the OCGR or the OCR according to occurrence of a ground fault or a short circuit fault.

### CROSS-REFERENCE TO RELATED APPLICATION

This application clams priority to and the benefit of Korean Patent Application No. 10-2007-0097856, filed on Sep. 28, 2007, the entire content of which are incorporated herein by reference.

### BACKGROUND OF THE INVENTION

1. Field of the Invention

The present invention relates to control of an electric power system, and more particularly to a control method for, upon occurrence of a power source fault of a protective relay in an electric power system, preventing malfunction of an over current ground relay (OCGR) due to reverse power.

2. Description of the Related Art

In recent years, power distribution systems, such as solar power generation systems and wind power generation systems, are increasing demand for distributed power generation. Such a power distribution system manages loads and power sources that are mixed with each other differently from conventional systems using downstream power supplies, and supplies power using bidirectional power supplies. Accordingly, power basically flows from a power distribution system of higher priority to a customer of lower priority through an existing protective relay in the power distribution system or the consumer.

Distribution lines in power distribution sources generating power flows mainly use multiple ground connections.

There occur ground faults on almost all (more than 97 percent) of the distribution lines using multiple ground connections. A main problem due to a ground fault is frequent malfunction of a protective relay located near a point where the ground fault occurs. Malfunction of a protective relay resulting from a power source fault causes two main disadvantages. That is, malfunction of a protective relay may require a resident worker to be available at any time, and it may be very time-consuming for a maintenance worker to search for a fault location particularly when the maintenance worker misunderstands the cause of malfunction of a protective relay as a load fault.

### SUMMARY OF THE INVENTION

The present invention has been made in view of the above problems, and the present invention provides a control method for preventing malfunction of an over current ground relay (OCGR) due to reverse power that, upon occurrence of a ground fault in a load of a protective relay, enables normal operation of the OCGR and, even upon occurrence of a ground fault in a power source of the protective relay, enables prevention of malfunction of the protective relay.

In accordance with an exemplary embodiment of the present invention, there is provided A control method for preventing malfunction of an over current ground relay (OCGR) due to reverse power, the control method including: determining directions of per-phase power flows by measuring the magnitudes and phases of per-phase voltages and currents in an electric power system; checking occurrence of a load fault or a power source fault using the determined directions of per-phase power flows; and controlling an over current ground relay (OCGR) or an over current relay (OCR) to transmit a trip signal to a circuit breaker, after, upon occurrence of a load fault, checking occurrence of a ground fault and checking occurrence of a short circuit fault, and, upon occurrence of a power source fault, checking occurrence of a short circuit fault without checking occurrence of a ground fault, by turning on or off the OCGR or the OCR according to occurrence of a ground fault or a short circuit fault.

In determining directions of power flows, in the case of location of forward power (+P=VIcosθ1) and reverse power (−P=VI VIcosθ2) for a single phase on a vector plane, when a phase difference of current is larger than −90 degrees and smaller than 90 degrees with reference to voltage on the X-axis, it may be determined that there is a forward power flow since the current has a phase angle corresponding to forward power and is located in the first and fourth quadrants of the vector plane, and when a phase difference of current is smaller than −90 degrees and larger than 90 degrees with reference to the voltage on the X-axis, it is determined that there is reverse power flow since the current has a phase angle corresponding to reverse power and is located in the second and third quadrants of the vector plane.

In determining directions of per-phase power flows, upon reversal of the directions of power flows in a power source and a load of a protective relay with respect to an installation point of the protective relay, a set value for the power source of the protective relay and a set value for the load may be automatically reversed.

In checking occurrence of a load fault or a power source fault, upon occurrence of a ground fault, due to a connection (Y-Y-A and Y-A) of a transformer, there is a reverse V connection available in the primary coil of the transformer and fault currents for A-, B-, and C-phases have almost the same phases. As illustrated in FIG. 5A, upon occurrence of a C-phase ground fault in a load of a protective relay, forward direction may be easily determined due to a large magnitude of ground fault current. On the other hand, as illustrated in FIG. 5B, upon occurrence of a power source fault, C-phase current is determined to be in a reverse direction. Therefore, upon application of the phase differences (0 degrees, 120 degrees, and 240 degrees) of voltage for A-, B-, and C-phases, in the case of a load fault, directions of three-phase power flows are forward power flows or reverse power flows only, but in the case of a power source fault, directions of power flows for A-, B-, and C-phases are different. This principle enables determination of occurrence of a power source fault or a load fault.

In controlling an OCGR or an OCR, upon occurrence of a load fault in checking occurrence of a load fault or a power source fault, first, fault current is normally detected in the OCGR, and upon occurrence of a power source fault in checking occurrence of a load fault or a power source fault, a trip signal may be transmitted to the circuit breaker after detecting fault current of the OCR with the operation of the OCGR being stopped.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view illustrating connections of a transformer used in an electric power system;

FIG. 2 is a view illustrating an example of malfunctions of a protective relay that, upon occurrence of a ground fault, occur for respective fault locations;

FIG. 3 is a view illustrating an example of directions of per-phase power flows that occurs when ground faults occur in the same transformer bank of a substation;

FIG. 4A is a view illustrating an example of directions of power flows in the case of a ground fault in a power source of a protective relay;

FIG. 4B is a view illustrating an example of directions of power flows in the case of a ground fault in a load of a protective relay;

FIG. 5A is a vector diagram illustrating fault currents for A-, B-, and C-phases in the case of a ground fault in a load of a protective relay;

FIG. 5B is a vector diagram illustrating fault currents for A-, B-, and C-phases in the case of a ground fault in a power source of a protective relay;

FIG. 6 is a flowchart illustrating an operation of a conventional OCR;

FIG. 7 is a flowchart illustrating a control method for preventing malfunction of an OCGR due to reverse power according to an embodiment of the present invention;

FIG. 8A is a circuit diagram used for searching for a fault location in a load of a protective relay;

FIG. 8B is a vector diagram illustrating an algorithm for determination of directions of power flows according to the phase differences of voltage and current.

FIG. 9A is a view illustrating an example of setting of a protective relay in the case of a forward flow operation; and

FIG. 9B is a view illustrating an example of setting of a protective relay in the case of a reverse flow operation.

### DETAILED DESCRIPTION OF THE INVENTION

Hereinafter, prior to the description of an embodiment of the present invention, malfunction of a protective relay that occurs in a power distribution system will be described in detail.

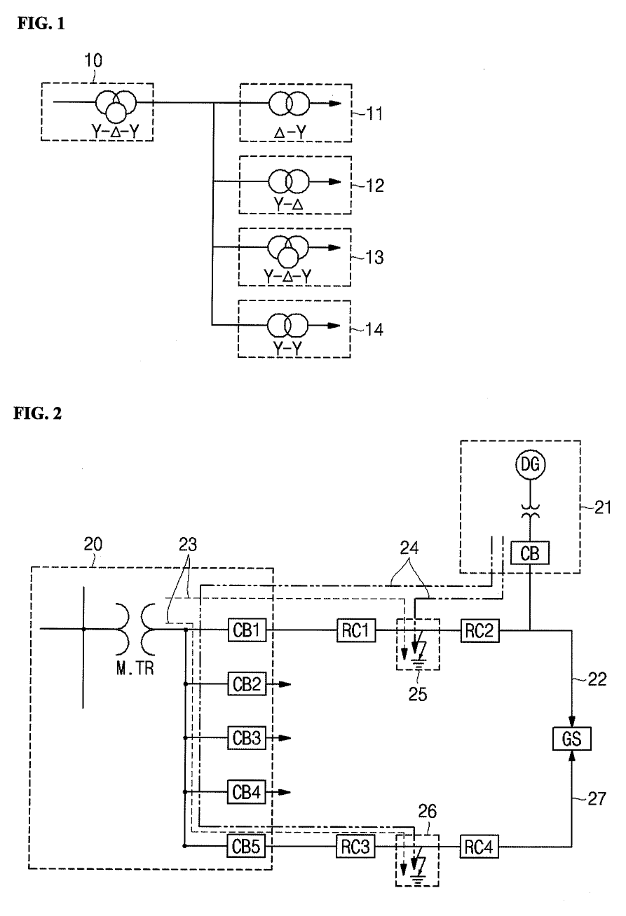

Referring to FIG. 1, connections of a transformer used in an electric power system are illustrated. As illustrated in FIG. 1, there is a Y-A (delta)-Y connection generally available in a main transformer 10 of a 154 KV/22.9 KV substation, a A-Y connection available in a receiving transformer 11 thereof, and a Y-A or Y-A-Y connection available in transmitting transformers 12 and 13 thereof. A distribution transformer 14 may be a pole transformer installed in an electric pole or a ground transformer installed on the ground, and there is a Y-Y connection available in all types of distribution transformers.

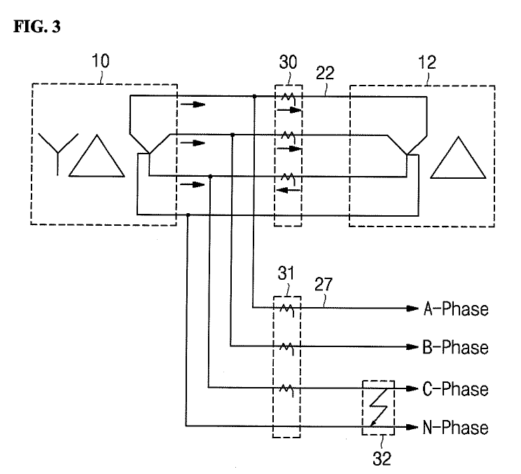

FIG. 2 is a block diagram illustrating an example of malfunctions of a protective relay that are related to locations of ground faults.

As illustrated in FIG. 2, upon occurrence of a ground fault at a first point 25, fault current 23 generated in almost all cases in a power receiving device 20 of a substation flows to the first point 25 where the ground fault occurred via a circuit breaker CB1 of the power receiving device 20, and the remaining fault current 24 generated in distributed power generation equipment 21 flows to the first point 25 where the ground fault occurred via a circuit breaker CB in a customer and a second recloser RC2 for a distribution line.

Then, in a normal operation of the OCGR, a first recloser RC1 for a distribution line may be tripped by cooperation between the circuit breaker CB1 of the receiving device 20 of the substation and the first recloser RC1 for a distribution line, and at the same time, trips the circuit breaker CB in a customer by operation of a protective relay, such as an under voltage relay (UVR) and an under frequency relay (UFR), installed in the distributed power generation equipment 21, in which case the distributed power generation equipment 21 is separated from the system. Generally, upon occurrence of a load fault, a protective relay is activated, but upon occurrence of a power source fault, a protective relay is inactivated.

However, there are occasions in which, in spite of occurrence of a ground fault in a power source at the first point 25, the second recloser RC2 malfunctions due to reverse power generated by the distributed power generation equipment 21.

On the other hand, upon occurrence of a ground fault at a second point 26, fault current 24 flows to a circuit breaker CB5 of the power receiving device 20 of the substation and a third recloser RC3 installed on a distribution line so that the third recloser RC3 may be tripped by cooperation between the circuit breaker CB5 of the power receiving device 20 and the third recloser RC3. However, there are abnormal occasions in which the circuit breaker CB1 of the power receiving device 20 of the substation, the first recloser RC1, the second recloser RC2, and the circuit breaker CB in the customer malfunction. This is because reverse power flows from the load to the power source due to a Y-A or Y-A-Y connection available in the transformer of the distributed power generation equipment 21, causing malfunction of the circuit breaker CB1 of the power receiving device 20 of the substation and the first and second reclosers RC1 and RC2.

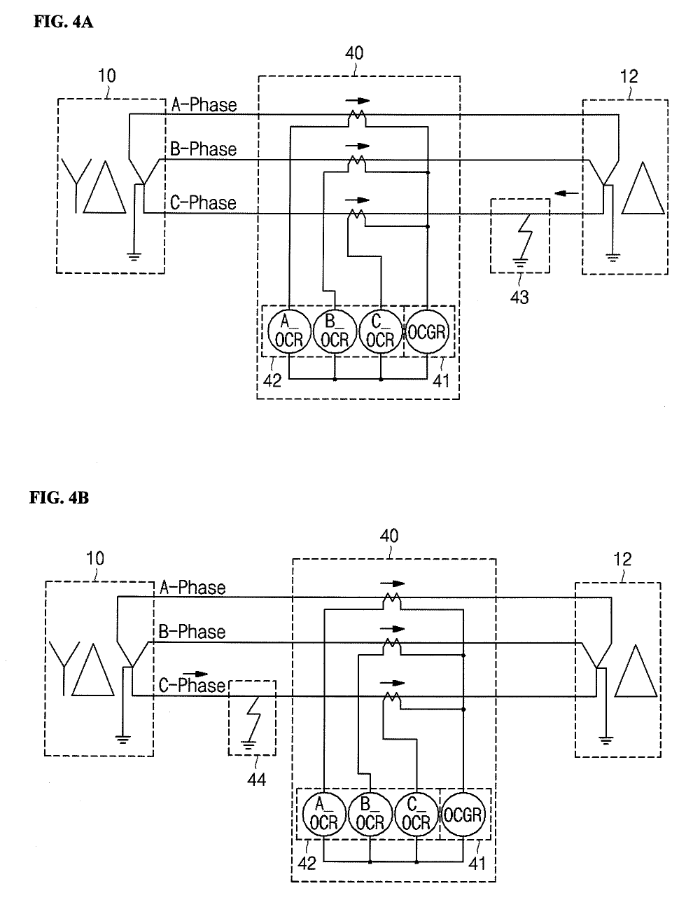

FIG. 3 is a view illustrating directions of per-phase power flows that occurs when ground faults occur in the same transformer bank of a substation.

FIG. 3 illustrates occurrence of a ground fault at a point 32 on the C-phase load side of an installation point of a protection device 31 on a distribution line having no power distribution source when an interconnection transformer 12 is associated with the main transformer 10 of the substation and the power distribution source. Then, it should be guaranteed that a protective relay of the protection device 31 that is installed on a fault line is normally operated at the point where the ground fault occurred and a protective relay of the protection device 30 that is installed on a nearby distribution line in the same transformer bank is not operated due to a power source fault. However, as described with reference to FIG. 2, an OCGR installed on a line where there are the circuit breaker CB1 of the substation, the first and second reclosers RC1 and RC2, and the circuit breaker in the customer malfunctions owing to its inability to detect directionality due to reverse power. More particularly, upon occurrence of a ground fault at a point 32 in the C-phase, voltage for the A- and B-phases slightly increases and voltage for the C-phase rapidly decreases between the substation and the point where the ground fault occurred. Then, there is a reverse V connection available in the primary coil of the interconnection transformer 12 and a A connection available in the secondary coil thereof on a nearby line, in which case voltage obtained by vector addition (Va+Vb=Vc) on the A- and B-phases is generated in the interconnection transformer 12 so that reverse power may be supplied toward the point where the ground fault occurred. Accordingly, there occur a forward power flow, a forward power flow, and a reverse power flow in the A-, B-, and C-phases of the protection device 30 installed on the nearby line respectively, and occurs unbalance current of more than 200 percent on a neutral line, in which case the OCGR malfunctions.

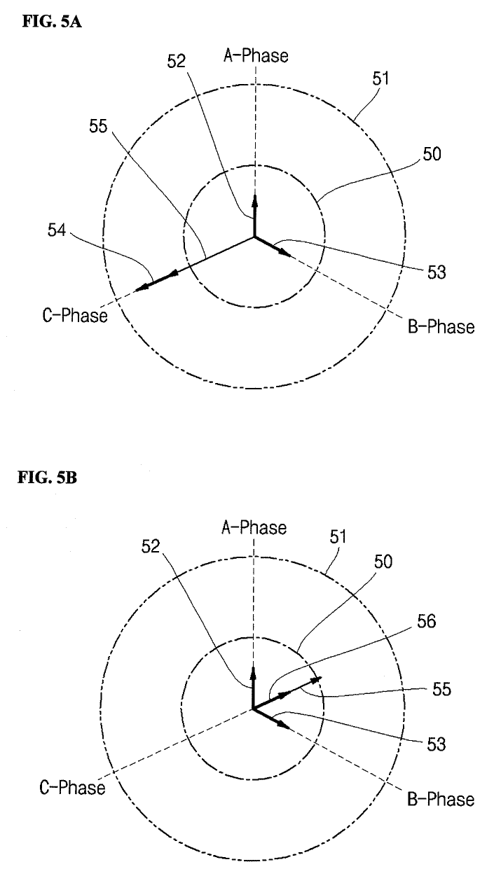

FIGS. 4A and 4B are views illustrating examples of directions of power flows in the case of ground faults in a power source and a load of a protective relay respectively.

As illustrated in FIG. 4A, upon occurrence of a ground fault at a point 43 on the C-phase load side of a protective relay 40 installed between the main transformer 10 of the substation and the power distribution source both of which are associated with the interconnection transformer 12, voltage for the A- and B-phases slightly increases and voltage for the C-phase rapidly decreases between the substation and the point where the ground fault occurred. Then, the C-phase fault current flows in almost all cases from the main transformer 10 toward the load to a fault point via the protective relay 40, and at the same time, the A- and B-phase currents are supplied from the interconnection transformer 12 on a nearby line. Then, the A- and B-phase voltages increase a little, and the C-phase voltage obtained by vector addition (Va+Vb=Vc) of the increased A- and B-phase voltages supplies reverse power flowing toward a point where the ground fault occurred via the protective relay 40. Vector addition of the A- and B-phase forward powers and the C-phase reverse power of the ground fault current detected by the protective relay 40 is carried out to generate unbalance current on the neutral line, in which case the protective relay 40 malfunctions.

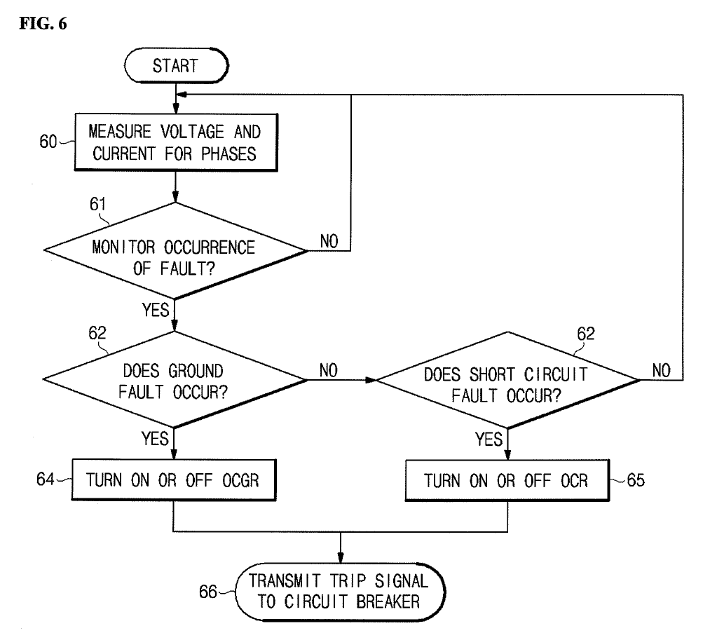

FIGS. 5A and 5B is a vector diagram illustrating the magnitude and phases of fault currents for A-, B-, and C-phases in the case of a ground fault in a load and a power source of a protective relay.

The A-, B-, C-phase fault currents generated when a ground fault is generated in the load of the protective relay 40 as described with reference to FIG. 4A may be illustrated in a vector diagram of FIG. 5A.

In FIG. 5A, the A-, B-, C-phase fault currents detected to check a fault in the protective relay 40 are all in the forward direction. In this case, N-phase fault current forms reversed C-phase fault current obtained by vector addition of the N-phase fault current and the C-phase fault current in the A- and B-phases. Accordingly, FIG. 5A illustrates that a power flow obtained by vector addition (Ia+Ib+Ic=−In) of a forward power flow and a reverse power flow by the main transformer occurs on the neutral line.

When the magnitude of the ground current is smaller than the maximum value 51 of a current setting range of an over current relay (OCR) 42, the OCR 42 is not operated. On the other hand, when the magnitude of the ground current is smaller than the minimum value 50 of the current setting range of the OCR 42, the OCR 42 is normally operated.

The A-, B-, C-phase fault currents generated when a ground fault is generated in the power source of the protective relay 40 as described with reference to FIG. 4B may be illustrated in a vector diagram of FIG. 5B.

In FIG. 5B, the A- and B-phase fault currents 52 and 53 detected by the protective relay 40 are in the forward direction. The C-phase current 56 is obtained by vector addition (A-phase+B-phase=C-phase) of the A- and B-fault currents. The N-phase fault current obtained by vector addition (Ia+Ib=In) of current obtained by addition of the A- and B-phase currents and the reverse C-phase fault current occurs on the neutral line. When the unbalance current occurring on the neutral line forms over current of more than 200%, the OCGR malfunctions.

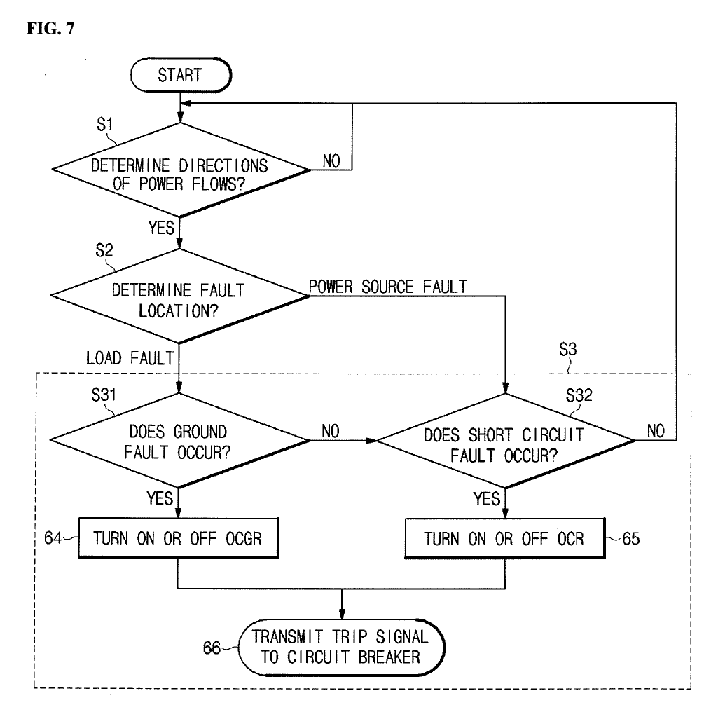

FIG. 6 is a flowchart illustrating an operation of a conventional OCR.

As illustrated in FIG. 6, in the step 60, voltage and current are measured though a current transformer (CT) and a potential transformer (PT), and in the step 61, occurrence of a fault on a distribution line is continuously monitored. Upon occurrence of a fault in the distribution line, occurrence of a ground fault in a protective relay or a short circuit relay is checked in the step 62. Then, upon occurrence of a ground fault, an OCGR 64 is operated in the step 64 and a circuit breaker is tripped in the step 66, or otherwise, it is determined that the fault on the distribution line is a short circuit fault in the step 63 and an OCR 65 is operated in the step 65.

Accordingly, upon occurrence of a ground fault, as mentioned above, a conventional OCR installed in a circuit breaker and a recloser generates unbalance current on a neutral line due to reverse power, in which case an OCGR malfunctions.

Hereinafter, an exemplary embodiment of the present invention will be described in detail with reference to the accompanying drawings. The same reference numerals are used throughout the drawings to refer to the same or like parts. The description of the same parts may be omitted.

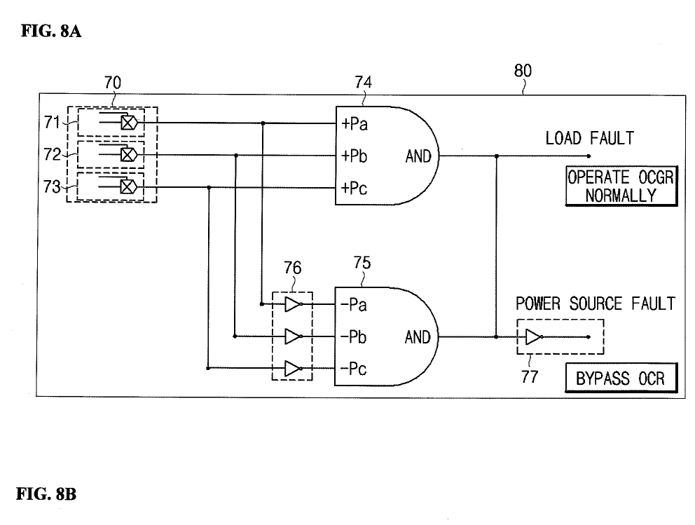

FIG. 7 is a flowchart illustrating a control method for preventing malfunction of an OCGR due to reverse power according to an embodiment of the present invention.

As illustrated in FIG. 7, the control method for preventing malfunction of an OCGR due to reverse power according to the embodiment of the present invention includes the step S1 of determining directions of power flows, the step S2 of searching for a fault location, and the step S3 of controlling a protective relay.

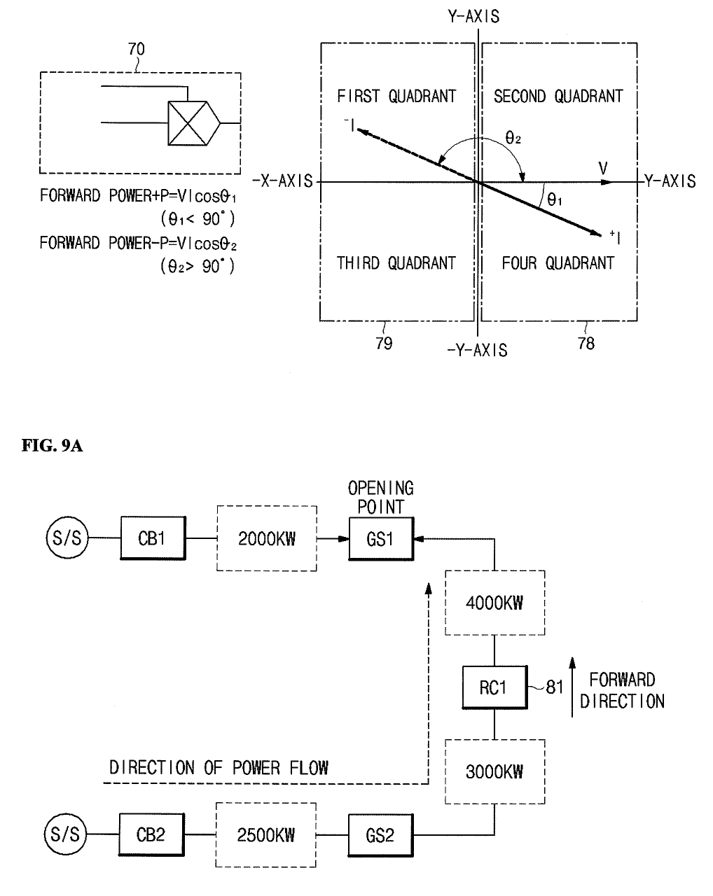

In the step S1, directions of power flows are determined by measuring the magnitudes and phases of per-phase voltages and currents in an electric power system. In this case, referring to FIGS. 8A and 8B for the detailed description of an example of the step S1 of detecting directions of power flows, FIG. 8A is a circuit diagram used for searching for a fault location in a load of a protective relay, and FIG. 8B is a vector diagram illustrating an algorithm for determination of directions of power flows according to the phase differences of voltage and current. As illustrated in FIG. 8, a circuit module 80 for searching for a fault location of a load includes circuits 71, 72, and 73 for measuring per-phase forward power flows, a circuit 74 for determining a three-phase forward power flow, and a circuit 75 for determining a three-phase reverse power flow. In this case, the circuit 74 for determining a three-phase forward power flow and the circuit 75 for determining a three-phase reverse power flow are electrically connected to a circuit 76 for reversing directions of per-phase power flows, so that signals indicating directions of power flows that are opposite to each other are input to the circuits 74 and 75 for determining three-phase forward and reverse flows respectively. As illustrated in FIG. 8B, in the case of location of forward power (+P=VIcosθ1) and reverse power (−P=VIcosθ2) for a single phase on a vector plane, when the absolute value of a phase difference of current is larger than −90 degrees and smaller than 90 degrees with reference to voltage on the X-axis, the circuit 74 for determining a three-phase forward power flow determines that there is a forward power flow since the current has a phase angle corresponding to forward power and is located in the first and fourth quadrants of the vector plane. On the other hand, as illustrated in FIG. 8B, when the absolute value of a phase difference of current is smaller than −90 degrees and larger than 90 degrees with reference to the voltage on the X-axis, the circuit for determining a three-phase reverse flow power determines that there is a reverse power flow since the current has a phase angle corresponding to reverse power and is located in the second and third quadrants of the vector plane.

In the step S2 of searching for a fault location, occurrence of a load fault or a power source fault is checked using the determined directions of power flows. The principle is that upon occurrence of a ground fault, due to a connection (Y-Y-A and Y-A) of a transformer, there is a reverse V connection available in the primary coil of the transformer and fault currents for A-, B-, and C-phases have almost the same phases. As illustrated in FIG. 5A, upon occurrence of a C-phase ground fault in a load of a protective relay, forward direction may be easily determined due to a large magnitude of ground fault current. On the other hand, as illustrated in FIG. 5B, upon occurrence of a power source fault, C-phase current is determined to be in a reverse direction. Therefore, upon application of the phase differences (0 degrees, 120 degrees, and 240 degrees) of voltage for A-, B-, and C-phases, in the case of a load fault, directions of three-phase power flows are forward power flows or reverse power flows only, but in the case of a power source fault, directions of power flows for A-, B-, and C-phases are different. This principle enables determination of occurrence of a power source fault or a load fault.

The step S3 of controlling a protective relay may be performed in consideration of two cases of a load fault and a power source fault.

In the step S31 of controlling a protective relay, upon determination of occurrence of a load fault, occurrence of a ground fault is checked in the step S31 and then occurrence of a short circuit fault is checked in the step S32. After checking occurrence of a ground fault in the S31, when the magnitude of ground fault current is greater than a set value of the OCGR, a trip signal is transmitted to a circuit breaker in the step 66 by turning on the OCGR in the step 64. On the other hand, when the magnitude of the ground fault current is smaller than the set value of the OCGR in the step 64, occurrence of a short circuit fault is checked in the step S32 without operating the OCGR in the step 64. In the step S32 of checking occurrence of a short circuit fault, when the magnitude of ground fault current is greater than a set value 51 of the OCR, a trip signal is transmitted to a circuit breaker by turning on the OCR in the step 65. On the other hand, when the magnitude of the ground fault current is smaller than the set value 51 of the OCR in the step 65, directions of power flows is determined again in the initial step of S1.

In the control method including the steps S1, S2, and S3 according to the embodiment of the present invention, upon occurrence of a ground fault on a load of a protective relay, an OCGR is normally operated, and upon occurrence of a ground fault on a power source of a protective relay, the OCGR is prevented from malfunctioning due to unbalance current on a neutral line due to reverse power.

In the step S3 of controlling a protective relay, upon on occurrence of reverse power flow in at least one of the phases that are determined in the step S1 of determining directions of flows, the step S31 of checking occurrence of a ground fault is omitted and a trip signal may be transmitted to a circuit breaker by checking only occurrence of a short circuit fault in the step S32. That is, upon occurrence of reverse power flow in at least one of the three-phases of the circuits 71, 72, and 73 for measuring per-phase forward power flows, an OCR bypass circuit 77 omits the step S31 of checking occurrence of a ground fault and checking only occurrence of a short circuit fault in the S32. Accordingly, upon occurrence of a fault in a power source of a protective relay, the OCGR is further prevented from malfunctioning due to unbalance current on a neutral line due to reverse power.

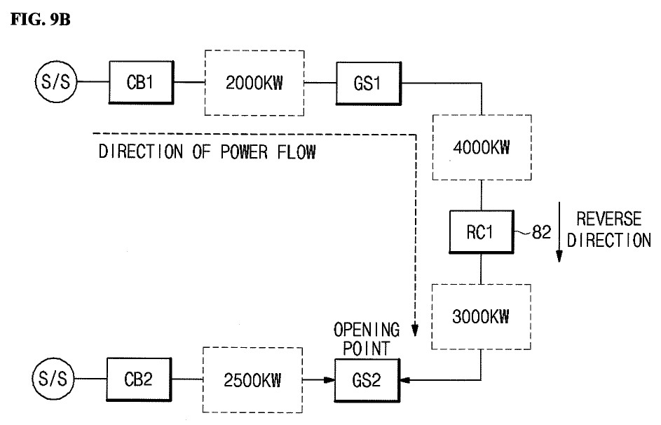

Meanwhile, upon reversing of the directions of power flows in a power source and a load of a protective relay in FIGS. 9A and 9B, a set value (4,000 KW) for the forward power flow of the power source of the protective relay and a set value (3,000 KW) for the reverse power flow of the load thereof are automatically reversed in the step S1 of measuring directions of power flows. That is, an existing power distribution system may be operated by adjusting an operation point (a normal opening point) according to the situation of the field or a power distribution system associated with a power distribution source may be operated in the form of a loop using a duplex power, so that directions of power flows are reversed according to operation situations of the power source and load of the protective relay at an installation point of the protective relay. Accordingly, in an existing protective relay setting method, set values of a protective relay are reset according to a situation in which set values for a power source and a load of the protective relay are manually reversed. However, according to the embodiments of the present invention, set values of a protective relay are actively reset normally, by automatic determination of directions of power flows by the protective relay.

According to the present invention, upon occurrence of a power source fault in a protective relay, an OCR prevents malfunction of an OCGR due to unbalance current on a neutral line that is generated by reverse power.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A control method for preventing malfunction of an over current ground relay (OCGR) due to reverse power, the control method comprising:
determining directions of per-phase power flows by measuring the magnitudes and phases of per-phase voltages and currents in an electric power system;
checking occurrence of a load fault or a power source fault using the determined directions of per-phase power flows; and
controlling an over current ground relay (OCGR) or an over current relay (OCR) to transmit a trip signal to a circuit breaker, after, upon occurrence of a load fault, checking occurrence of a ground fault and checking occurrence of a short circuit fault, and, upon occurrence of a power source fault, checking occurrence of a short circuit fault without checking occurrence of a ground fault, by turning on or off the OCGR or the OCR according to occurrence of a ground fault or a short circuit fault.

2. The control method of claim 1, wherein in determining directions of power flows, in the case of location of forward power (+P=VIcosθ1) and reverse power (−P=VI VIcosθ2) for a single phase on a vector plane, when a phase difference of current is larger than −90 degrees and smaller than 90 degrees with reference to voltage on the X-axis, it is determined that there is a forward power flow since the current has a phase angle corresponding to forward power and is located in the first and fourth quadrants of the vector plane, and when a phase difference of current is smaller than −90 degrees and larger than 90 degrees with reference to the voltage on the X-axis, it is determined that there is reverse power flow since the current has a phase angle corresponding to reverse power and is located in the second and third quadrants of the vector plane.

3. The control method of claim 2, wherein in determining directions of per-phase power flows, upon reversal of the directions of power flows in a power source and a load of a protective relay with respect to an installation point of the protective relay, a set value for the power source of the protective relay and a set value for the load are automatically reversed.

4. The control method of claim 1, wherein in controlling an OCGR and an OCR, in the case of occurrence of a load fault in checking occurrence of a load fault or a power source fault, after checking occurrence of a ground fault, when the magnitude of ground fault current is greater than a set value of the OCGR, a trip signal is transmitted to a circuit breaker, and when the magnitude of the ground fault current is smaller than the set value of the OCGR, occurrence of a short circuit fault is checked, in which case when the magnitude of ground fault current is greater than a set value of the OCR, a trip signal is transmitted to a circuit breaker, and when the magnitude of the ground fault current is smaller than the set value of the OCR, determining directions of per-phase power flows is performed again.

5. The control method of claim 1, wherein in controlling an OCGR and an OCR, in the case of occurrence of a power source fault in checking occurrence of a load fault or a power source fault, after checking only occurrence of a short circuit fault without checking occurrence of a ground fault, when the magnitude of ground fault current is greater than a set value of the OCR, a trip signal is transmitted to a circuit breaker, and when the magnitude of the ground fault current is smaller than the set value of the OCR, determining directions of per-phase power flows is performed again.
